(19) United States
(12) Patent Application Publication
(10) Pub. No.: US 2021/0335079 A1
(43) Pub. Date: Oct. 28, 2021

(54) SHARED EQUIPMENT LEASING DEVICE, METHOD AND SYSTEM THEREFOR

(71) Applicant: LANGOGO TECHNOLOGY CO., LTD, Shenzhen (CN)

(72) Inventors: Yan Zhang, Shenzhen (CN); Tao Xiong, Shenzhen (CN)

(21) Appl. No.: 16/470,556

(22) PCT Filed: Apr. 26, 2019
(86) PCT No.: PCT/CN2019/084551

§ 371 Date: Jun. 18, 2019

(30) Foreign Application Priority Data
Sep. 19, 2018 (CN) 201811094288.8
Sep. 29, 2018 (CN) 201811149588.1

(51) Int. Cl. G07F 17/00; G06Q 30/06; E05B 47/02; E05B 47/00

(52) U.S. Cl. CPC G07F 17/0042; E05B 47/0002; E05B 47/02; G06Q 30/0645

(57) ABSTRACT

A shared equipment leasing device, a method and a system therefor are provided, which are applied to a field of electronic technology, including a cabinet body and a power management module, the cabinet body being provided with a main chip, an electromagnetic lock, an equipment slot, a buckle and a spring. The main chip is electrically connected to the power management module and the electromagnetic lock. The buckle and the spring are arranged in the equipment slot, and the electromagnetic lock is connected to the buckle. The main chip is configured to control the electromagnetic lock to open or lock the buckle. The spring is configured to eject the shared equipment inserted in the equipment slot after the main chip controls the electromagnetic lock to open the buckle. The device, the method and the system can improve the convenience and usability for ejecting and inserting of the shared equipment.

### TECHNICAL FIELD

The present invention relates to a field of electronic technology, and in particular to a shared equipment leasing device, as well as a method and a system therefor.

### BACKGROUND

At present, the shared leasing cabinet commonly used in the market is a leasing cabinet for shared power bank, which is very convenient with being unattended all the time, and provides the users with self-service capabilities in leasing, returning, paying and deducting, etc. The shared leasing cabinet in the prior art is adapted for the shared power bank that is merely a charging equipment with a simple structure, a small data volume and a single function, and without any individual operating system. However, for the intelligent equipment with a more complicated structure, such as a translation machine, provided with a individual operating system such as Android, Linux, etc., and various kinds of data such as equipment data, application data, etc. stored therein, it is unsafe and inconvenient to insert such equipment into the storage slot during taking out and returning back, as such equipment itself has a complex structure with many parts, and is configured in various types. Therefore, the typical leasing cabinet has its structure that does not match with the equipment such as the translation machine and thus could not meet the needs of shared leasing business for equipment such as translation machine.

### SUMMARY

The present invention provides a shared equipment leasing device, as well as a method and a system therefor, which, by means of mutual cooperation of an electromagnetic lock, a buckle and a spring, solve the problem that it's inconvenience to eject the shared equipment from a slot or to insert the shared equipment into the slot.

According an embodiment of the present invention, a shared equipment leasing device is provided, including a cabinet body and a power management module, the cabinet body being provided with a main chip, an electromagnetic lock, an equipment slot, a buckle and a spring arranged therein;

the main chip is electrically connected to the power management module and the electromagnetic lock;

the buckle and the spring are arranged in the equipment slot, and the electromagnetic lock is connected to the buckle;

the main chip is configured to control the electromagnetic lock to open or lock the buckle;

the spring is configured to eject the shared equipment inserted in the equipment slot after the main chip controls the electromagnetic lock to open the buckle.

According an embodiment of the present invention, a shared equipment leasing method is provided, which is applied to leasing a shared equipment through the above-mentioned shared equipment leasing device that includes a cabinet body having a main chip, a power management module, an electromagnetic lock and an equipment slot provided therein, wherein the equipment slot includes a buckle and a spring arranged therein, the main chip is electrically connected to the power management module and the electromagnetic lock, and the electromagnetic lock is connected to the buckle, the method including:

controlling the electromagnetic lock to open the buckle by the main chip in response to a leasing operation, and ejecting the shared equipment inserted in the equipment slot by the spring;

controlling the electromagnetic lock to lock the buckle by the main chip when the shared equipment is inserted into the equipment slot, so that the buckle locks the shared equipment.

According an embodiment of the present invention, a shared equipment leasing system is provided, including a shared equipment provided a built-in RFID chip, a leasing device and a cloud server;

wherein the leasing device includes a cabinet body, a power management module, a communication module and an interpreter, the cabinet body being provided with a main chip, an electromagnetic lock, an equipment slot, a buckle and a spring arranged therein;

a data connection between the leasing device and the cloud server is established through the communication module;

the leasing device is configured to, in response to a leasing operation and by means of the main chip, control the electromagnetic lock in the leasing device to open the buckle in the target equipment slot to which the leasing information is directed, and to eject the shared equipment inserted in the equipment slot by the spring in the target equipment slot;

the leasing device is further configured to control the electromagnetic lock to lock the buckle so as to lock the inserted shared equipment by the main chip when the shared equipment is inserted into the equipment slot, and to control the power management module to charge the inserted shared equipment, and to read a unique identification information of the inserted shared equipment stored in the RFID chip by the interpreter, and to send the unique identification information to the cloud server through the communication module;

the leasing device is further configured to perform a malfunction detection on the inserted shared equipment by the main chip, and to send the unique identification information and a malfunction information of the inserted shared equipment to the cloud server when a malfunction of the inserted shared equipment is detected.

According to the above mentioned embodiments of the present invention, the shared equipment leasing device, the shared equipment leasing method and the shared equipment leasing system are provided, wherein the electromagnetic lock is controlled to open the buckle by the main chip of the shared equipment leasing device and the shared equipment is ejected by the spring of the equipment slot, and wherein the electronic holder is controlled to lock the shared equipment by the main chip when the shared equipment is inserted into the equipment slot. The leasing device could have its usability improved with more convenience for ejecting or inserting the shared equipment due to the setting of the electromagnetic lock, the buckle and the spring.

### BRIEF DESCRIPTION OF THE DRAWINGS

FIG. 1 schematically shows a structural view of an adjusted shared equipment leasing device according to an embodiment of the present invention;

FIG. 2 schematically shows an external structural view of the shared equipment leasing device according to an embodiment of the present invention;

FIGS. 3-5 schematically show various views of an internal structure of the shared equipment leasing device according to an embodiment of the present invention;

FIG. 6 schematically shows a structural view of an equipment slot of the shared equipment leasing device according to an embodiment of the present invention;

FIG. 7 schematically shows a flowchart of a shared equipment leasing method according to an embodiment of the present invention;

FIG. 8 schematically shows a structural view of a shared equipment leasing system according to an embodiment of the present invention;

FIG. 9 schematically shows a structural view of a shared equipment provided in the shared equipment leasing system according to an embodiment of the present invention.

### DETAILED DESCRIPTION

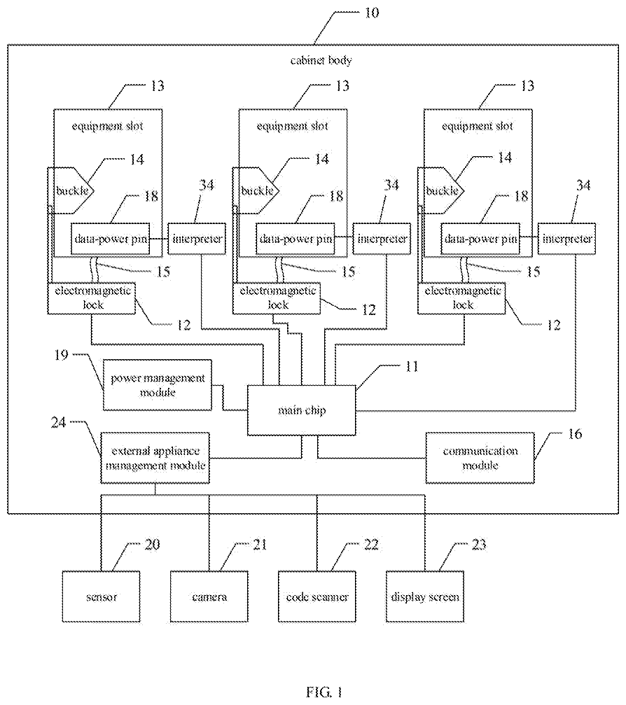

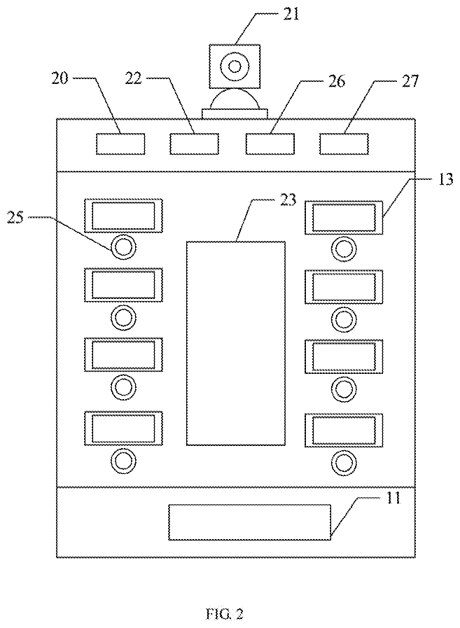

Referring to FIG. 1 and FIG. 2, FIG. 1 schematically shows a structural view of a shared equipment leasing device according to an embodiment of the present invention, and FIG. 2 schematically shows an external structural view of the shared equipment leasing device. The shared equipment includes intelligent electronic equipment such as translation machine with an individual operating system, such as Android or Linux, etc. Leasing here means renting and returning of the shared equipment. The shared equipment leasing device specifically might be a cabinet for leasing the shared equipment. The device includes a cabinet body 10 which includes a main chip 11, an electromagnetic lock 12, an equipment slot 13, a buckle 14, a spring 15 and a power management module 19.

The main chip 11 may be a micro control unit (MCU), which is connected to the electromagnetic lock 12, and can control the electromagnetic lock 12 to open or lock the buckle 15. The power management module 19 may be, for example, a control chip or a control circuit for power management, and is configured to connect a charging plug, a power adapter, or a charging line.

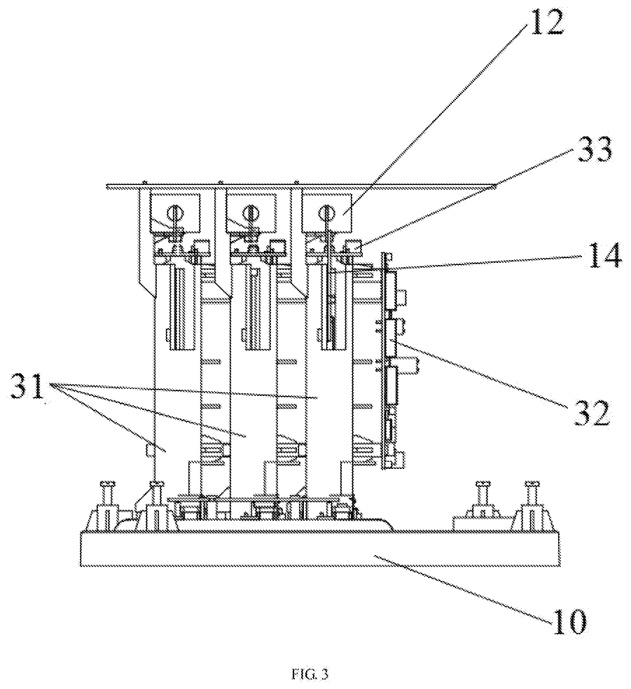

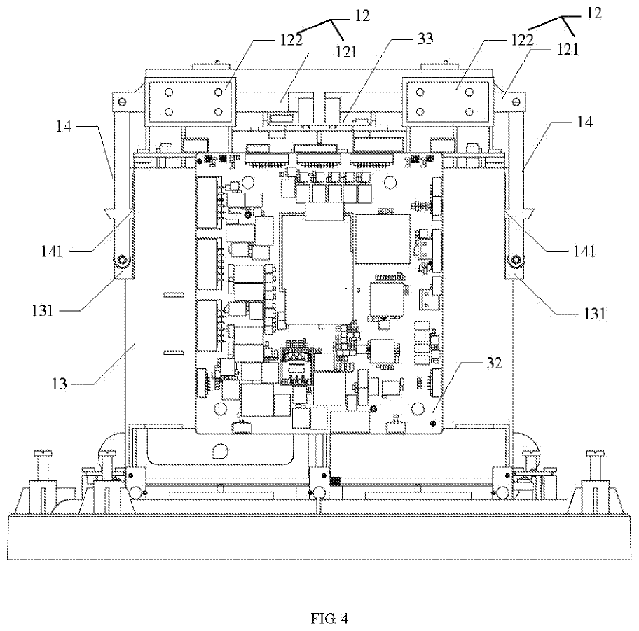

Referring to FIG. 2 to FIG. 6, FIG. 2 schematically shows an external structural view of the shared equipment leasing device according to an embodiment of the present invention, and FIGS. 3-5 schematically show various views of an internal structure of the shared equipment leasing device according to an embodiment of the present invention. FIG. 6 schematically shows a structural view of an equipment slot of the shared equipment leasing device according to an embodiment of the present invention. A plurality of equipment slots 13 may be provided in the shared equipment leasing device. Referring to an embodiment shown in FIG. 3, a plurality of equipment slots 13 (not shown in FIG. 3) are fixed in the cabinet body 10 via a plurality of racks 31. Each of the equipment slots 13 is provided with a buckle 14 and a spring 15 (not shown in FIG. 3 to FIG. 6).

Specifically, each of the equipment slots 13 might be provided with at least one spring 15 arranged inside the bottom of the respective equipment slot 13. Each of the equipment slots 13 is provided with at least one electromagnetic lock 12. Each of the at least one electromagnetic lock 12 is configured to open or lock at least one buckle 14. As shown in FIG. 4, two electromagnetic locks 12 are respectively arranged at the bottom of the equipment slot 13. Each electromagnetic lock 12 is connected to a respective buckle 14. The main chip 11 (not shown in FIG. 3 to FIG. 5) provided on the mainboard 32 is configured to control the electromagnetic lock 12 to open the buckle 14, such that the shared equipment 13 is ejected from the equipment slot 13 by the spring 15 and then is removed by the customer. The main chip is further configured to lock the buckle 14, such that the shared equipment is locked in the equipment slot 13 to prevent being removed by the customer.

Moreover, as shown in FIG. 4, the shared equipment leasing device further includes a control board 33 electrically connected to the main chip 11 and the electromagnetic lock 12. The electromagnetic lock 12 includes a connecting shaft 121 and a driver 122. The equipment slot 13 has one side perpendicular to the bottom of the equipment slot 13 and provided with a protrusion 131. The buckle 14 has one end fixed to the connecting shaft 121, and another end fixed to the protrusion 131. Specifically, the driver 122 might be, for example, a micro motor or other driving device having the same function. The control board 33 is electrically connected to the driver 122. The control board 33 is configured to, in response to the control command transmitted from the main chip 11, control the driver 122 to drive the connecting shaft 122 to move in a direction parallel to the bottom of the equipment slot 13, and then feedback a control result to the main chip 11. The connecting shaft 121 is driven by the driver 122 to move in a direction towards the equipment slot 13 and lock the buckle 14 in a preset position, and the protrusion 141 on the buckle 14 passes through the through hole in a side wall of the equipment slot 13 to press against the shared equipment in the equipment slot 13, such that the shared equipment is locked. When the driver 122 drives the connecting shaft 121 to move in a direction towards the cabinet body 10, the buckle 14 is opened, such that the shared equipment in the equipment slot 13 is no longer pressed against by the protrusion 141 on the buckle 14 and is ejected by the spring 15 at the bottom of the equipment slot 13.

Moreover, when the user returns the shared equipment, the shared equipment is inserted into the equipment slot 13, at which time the main chip 11 controls the electromagnetic lock 12 to lock the buckle 14 so as to lock the shared equipment. Meanwhile, the main chip 11 can charge the shared equipment inserted into the equipment slot 13, read data from the shared equipment, and send the read data to the cloud server for processing. The data may include one or more of attribute data, elements data, local data, and application data, wherein the attribute data includes identification information such as a model number and a serial number (SN) of the shared equipment; the elements data includes data of the hardware such as a memory, a display screen, a bottom, a data line, a charging line, an earphone line and the like of the shared equipment; the local data and the application data are text and voice data generated by the user when using the shared equipment. Specifically, the shared equipment leasing device is further provided with a communication module 16 for transmitting data to the cloud server. The communication module 16 includes a cellular network communication module and a WiFi hotspot module, wherein the cellular network communication module can transmit data with the cloud server through a mobile communication network supporting 2G, 3G, 4G or subsequent versions of the cellular network protocol, and the WiFi hotspot module can transmit data with the cloud server through the wireless fidelity network. Data exchange between the shared equipment and the shared equipment leasing device is larger in volume, more variety, and more complex in logic, including not only the attribute data of the shared equipment, but also the elements data of the shared equipment and the application data carried by the operating system of the shared equipment.

Sending the read data to the cloud server for processing includes that the cloud server determines whether or not the shared equipment currently in the equipment slot 13 is a previously leased shared equipment according to the attribute information, and determines whether or not the shared equipment currently in the equipment slot is damaged according to the elements data. It should be noted that it is also possible for the main chip 11 to determine whether the shared device currently in the device card slot 13 is damaged based on the device data. The cloud server stores the local data and the application data in a database according to the association relationship with the shared equipment. For instance, a storage directory for the data of the shared equipment is established in the database, such that the local data and the application data of the shared equipment are stored in the storage directory after being read each time. During data interaction between the shared equipment leasing device and the cloud server, not only can the shared equipment leasing device report the data to the cloud server in real time, but also can the cloud server freely transmit various commands and information to the shared equipment leasing device, achieving a bi-directional communication and improving the speed and efficiency of the communication.

Specifically, the shared equipment leasing device further includes an interpreter 34. A radio frequency identification (RFID) chip is provided on the shared equipment, data of which can be read by the interpreter 34 in the shared equipment leasing device. The RFID chip into which a unique equipment code has been written is attached to the inside or back of the shared equipment at the time the shared equipment leaves the factory, such that the identity of the shared equipment can be confirmed by reading the unique equipment code stored in the RFID chip. The unique device code might be, for example, a serial number (SN) code, that is, a unique identification information of the shared equipment.

The bottom of each equipment slot 13 is provided with a data-power pin 18 extending beyond the bottom of the equipment slot 13. The shared equipment also provided with a data-power pin at the end portion of the shared equipment. The interface is exposed through the metal contacts at the end portion of the shared equipment. The data-power pin of the shared equipment corresponds to the data-power pin in the equipment slot 13.

The data-power pin 18 at the bottom of the equipment slot 13 includes a positive power pin and a negative power pin electrically connected to the power management module 19. Correspondingly, the data-power pin of the shared equipment includes a positive charging contact and a negative charging contact. The main chip 11 is further configured to charge the shared equipment when the positive and negative charging contacts of the shared equipment are respectively in contact with the positive and negative power pins of the data-power pin 18. The power management module 19 is connected to a power source, and the main chip 11 controls the power source to charge the shared equipment by sending a charging control command to the power management module 19.

Furthermore, the data-power pin 18 at the bottom of the equipment slot 13 further includes a first data transmission pin electrically connected to the interpreter 34. Correspondingly, the data-power pin of the shared equipment further includes a radio frequency identification (RFID) contact. The main chip 11 is further configured, when the radio frequency identification contact of the shared equipment is in contact with the first data transmission pin of the leasing device, to read the unique identification information stored in the RFID chip in the shared equipment via the interpreter 34, and to send the read unique identification information to the cloud server via the communication module 16.

Furthermore, the data-power pin 18 at the bottom of the equipment slot 13 further includes a second data transmission pin electrically connected to the main chip 11. Correspondingly, the data-power pin of the shared equipment further includes a data transmission pin electrically connected to a processor and/or a memory of the shared equipment.

The main chip is further configured to send a first command for clearing a first target data in the shared equipment to the shared equipment when the data transmission pin of the shared equipment is in contact with the second data transmission pin of the leasing device. The first target data includes the local data and the application data of the shared equipment. Specifically, the first command is used for commanding the shared equipment to perform an initialization operation to clear the local data and the application data of the shared equipment.

The main chip 11 is further configured, when the data transmission pin of the shared device is in contact with the second data transmission pin of the leasing device, to read a second target data in the shared equipment, and to send the second target data to the cloud server via the communication module 16. The second target data is, for example, at least one of the elements data, the local data, and the application data of the shared equipment.

The main chip 11 is further configured to send a second command for controlling restarting of the shared equipment to the shared equipment when the data transmission pin of the shared equipment is in contact with the second data transmission pin of the leasing device, and to send a malfunction information to the cloud server via the communication module 16 when the shared equipment fails to start. The main chip 11 is further configured to determine whether or not the shared equipment malfunctions according to the read second target data.

In an embodiment as shown in FIG. 6, six data-power pins 181-186 are provided at the bottom of the equipment slot 13, wherein the data-power pins 181 and 182 are a positive power pin GND and a negative power pin VBUS respectively, the data-power pins 183 and 184 are first data transmission pins TX1 and RX1, and the data-power pins 185 and 186 are second data transmission pins TX2 and RX2. The connection relationships between the data-power pins and the main chip 11 and the power management module 19 are not shown in FIG. 1.

Each of the data-power pins 18 at the bottom of the equipment slot 13 may contact the respective exposed data-power pin at the end portion of the shared equipment when the end portion of the shared equipment is fully inserted into the bottom of the equipment slot 13.

Moreover, a daze prevention design is made in the device card slot 13 in order to enable the shared equipment to be more smoothly inserted into the equipment slot 13 and to prevent the shared equipment from being inserted reversely when inserted into the equipment slot 13. Specifically, as shown in FIG. 6, a plurality of protruding ribs 132 are provided on side walls on an upper inner side and a lower inner side of the equipment slot 13 respectively. A plurality of ribs 132 extend from the notch of the equipment slot 13 towards the bottom of the equipment slot 13, and the ribs on the side wall of the upper inner side (which faces to the front side of the shared equipment that is typically the side with a display screen of the shared equipment) of the equipment slot 13 are of eccentric design, that is, an angle between the width-height surface of the rib and the side wall is provided, which ranges from 15 degrees to 80 degrees, for example.

Moreover, the depth of the equipment slot 13 is smaller than the length of the shared equipment, for example, when the end portion of the shared equipment is fully inserted into the bottom of the equipment slot 13, three quarters of the shared equipment is located inside the equipment slot 13 and the remaining quarter is exposed outside the equipment slot 13 for easy access by the user.

The shared equipment leasing device communicates with the RFID chip in a manner of contact communication, which not only remains the advantage of small size occupied by the RFID chip, but also avoids the defects that the radio frequency communication cannot control the distance and the transmission range. RFID read-writer and antenna would not be required inside the shared equipment leasing device, reducing cost for the hardware.

Moreover, the shared equipment leasing device further includes a plurality of external appliances detachably disposed on the outer surface of the cabinet body 10, the external appliances including a sensor 20, a camera 21, a code scanner 22, and a display screen 23. The shared equipment leasing device is provided with an external appliance management module 24, and the external appliance management module 24 controls the operation of the external appliances according to the commands from the main chip 11.

The sensor 20 is configured to detect whether a user approaches, and specifically may be an infrared sensor, a shock sensor, or the like.

The camera 21 is configured, under the control of the main chip 11, to acquire the user's characteristics by photographing a user or an identification document (ID) shown by the user, the user's characteristics including the user's facial characteristics, iris characteristics, fingerprint characteristics and other biological characteristics, as well as the user's name, ID number and other identity characteristics.

The code scanner 22 is configured to scan a barcode, which may be a pay barcode or a barcode that authenticates the user's identity.

The display screen 23 is configured to display the text prompt information and/or the interface for collection of user's characteristics, and the text prompt information may include the number, location or warning information of the shared equipment available for lease. The display screen 23 may be provided on the front of the shared equipment leasing device. The external appliances can be disassembled and replaced freely, which improves the convenience for use.

Moreover, each equipment slot 13 is provided with a leasing button 25 that is arranged on the front side of the cabinet 10 and beside the notch of the respective equipment slot 13. The leasing button 25 is pressed to trigger a leasing operation in response to which the main chip 11 starts to operate, such that the shared equipment in the respective equipment slot 13 can be leased by the user pressing the respective leasing button 25.

Moreover, the shared equipment leasing device is provided with a power indicator lamp 26 and a malfunction indicator lamp 27.

The power indicator lamp 26 is configured to show a power information of the shared equipment.

The malfunction indicator lamp 27 is configured to show a malfunction of the shared device.

Furthermore, an infrared sensor is disposed inside the notch of each equipment slot 13, and is electrically connected to the main chip 11 for collecting infrared sensing data according to the sensed data and sending the infrared sensed data to the main chip 11. The main chip 11 is further configured to determine whether the equipment slot to which an ejecting control command is pointed is still occupied after a preset time period is exceeded according to the sensed data sent by the infrared sensor after the ejecting control command is sent to the electromagnetic lock, and if occupied, a locking control command is sent to the electromagnetic lock to cause the electromagnetic lock to re-lock the buckle, thereby ensuring the safety of the shared equipment and ensuring the accuracy of the leasing data.

In the embodiment according to the present invention, the electromagnetic lock is controlled to open the buckle by the main chip of the shared equipment leasing device and the shared equipment inserted in the equipment slot is ejected by the spring, and wherein the electronic holder is controlled to lock the shared equipment by the main chip when the shared equipment is inserted into the equipment slot. The leasing device could have its usability improved with more convenience for ejecting or inserting the shared equipment due to the setting of the electromagnetic lock, the buckle and the spring. Moreover, by means of charging the shared equipment by the data-power pin, reading various data from the shared equipment, and sending the read data to the cloud server for processing, the data processing capability in the shared equipment can be improved, the data processing success rate and the data processing amount of the shared equipment in the leasing process are greatly improved, so that the leasing process is successfully completed, and the shared leasing service demand for the shared equipment with a more complex structure is met, and the user experience is improved.

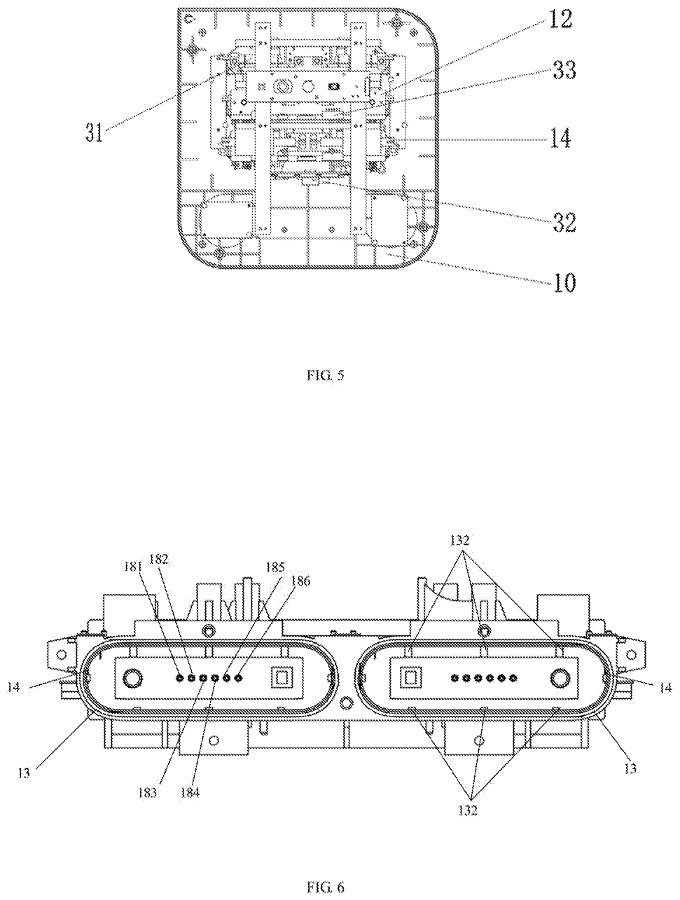

Referring to FIG. 7, it schematically shows a flowchart of a shared equipment leasing method according to an embodiment of the present invention, which can be used to realize shared equipment leasing through the shared equipment leasing device in the foregoing embodiment. The structure of the shared equipment leasing device in this embodiment refers to the foregoing embodiment shown in FIGS. 1 to 6, and the method includes the steps of:

S201, the leasing device controls the electromagnetic lock to open the buckle via the main chip in response to a leasing operation, and ejects the shared equipment inserted in the equipment slot via the spring;

wherein the main chip is electrically connected to the electromagnetic lock, the buckle and the spring are deposited in the equipment slot, the electromagnetic lock is connected to the buckle, and the specific structures of the shared equipment leasing device are referred to the foregoing embodiment shown in FIGS. 1 to 6.

The user can send a leasing request to the cloud server through the APP of a mobile phone, and the cloud server sends a leasing command to the main chip of the shared equipment leasing device to trigger the leasing operation. Alternatively, the user presses a leasing button on the shared equipment leasing device to trigger the leasing operation with the leasing button sending an electric signal to the main chip.

In response to the triggered leasing operation, the main chip controls the camera to be turned on, and the current user's characteristics and the leasing-related information are recognized through the recording of the camera and the code scanner, etc. The main chip controls the electromagnetic lock to open the buckle in the equipment slot, and the shared equipment inserted in the equipment slot is ejected by the spring arranged at the bottom of the equipment slot. The main chip updates and reports the leasing-related information of the shared equipment to the cloud server after the shared equipment is removed by the user, wherein the leasing-related information includes the user information of the lessee, the leasing starting time, the number of leasing times of the shared equipment, the model number, the attribute data, etc.

If it is determined that the equipment slot is still occupied after a preset time period is exceeded, which means that the shared equipment is not removed by the user, the main chip controls the electromagnetic lock to lock the buckle, so as to re-lock the shared equipment. Specifically, the main chip can determine whether the user removes the shared equipment according to the sensed data sent by the infrared sensor disposed inside the notch of each equipment slot.

S202, the electromagnetic lock is controlled to lock the buckle via the main chip when the shared equipment is inserted into the equipment slot, so that the buckle locks the shared equipment.

When returning the shared device, the user directly inserts the shared equipment into any one of the empty equipment slots, or inserts the shared equipment into a designated one of the empty equipment slots as instructed by the leasing APP. The main chip controls the electromagnetic lock to lock when the shared equipment is inserted into the equipment slot, so that the buckle in the equipment slot locks the shared equipment.

Moreover, when the shared equipment is inserted into the equipment slot, the leasing device acquires the unique identification information of the shared equipment through the built-in interpreter, controls the power management module to charge the shared device through the main chip and detects whether the shared equipment malfunctions.

If the shared device malfunctions, the malfunction information and the unique identification information of the shared equipment are sent to the cloud server through the main chip, and the malfunction indicator lamp of the leasing device is controlled to be illuminated and/or the malfunction information is displayed on the display screen of the leasing device. If the shared equipment does not malfunction, a data-clearing command is sent to the shared equipment through the main chip, the data-clearing command being used to clear the first target data in the shared equipment.

Alternatively, if the shared device does not malfunction, the second target data in the shared equipment is read through the main chip, and the unique identification information of the shared equipment and the read second target data are sent to the cloud server.

Detecting whether the shared equipment malfunctions may include commanding the shared equipment to restart through the main chip, determining that the shared equipment malfunctions if the shared equipment fails start, or determining that the shared equipment does not malfunction if the shared equipment starts successfully.

Alternatively, detecting whether the shared equipment malfunctions may further include, reading the elements data of the shared equipment if that share device starts successfully and comparing the read elements data with a preset data, determining that the shared equipment malfunctions if the elements data is not inconsistent with the preset data, or determining that the shared equipment does not malfunction if the elements data is consistent with the preset data.

After the shared equipment is inserted into the equipment slot, the main chip reads the attribute data of the shared equipment and charges the shared equipment. Moreover, the main chip also reads the elements data of the shared equipment, and determines whether the shared equipment is damaged according to the elements data, such as whether the screen is broken, whether the data line is missing, and the like. Alternatively, the main chip may send the elements data to the cloud server for determination.

Alternatively, the main chip controls the shared equipment to start, and if the shared equipment cannot start, malfunction information of the shared equipment is sent to the cloud server, and the malfunction indicator lamp of the shared equipment leasing device is controlled to be illuminated and/or the malfunction information is displayed on the display screen of the shared equipment leasing device.

The above-mentioned manners of determining whether the returned shared equipment is damaged and whether a malfunction occurs may be simultaneously performed, and the result is comprehensively confirmed according to the determined results. It will be appreciated that the malfunction detection described above may also be performed periodically for the shared equipment in the equipment slot.

Moreover, the shared equipment sends the attribute data and the elements data to the main chip after starting, and the main chip reports the attribute data and the elements data to the cloud server, or the shared equipment automatically runs the preset leasing APP after starting, sends the attribute data and elements data directly to the cloud server through the leasing APP. The deposit would be returned to the user from the leasing APP after the cloud server checks according to the received attribute data and the elements data to confirm that the returned shared equipment is the one previously leased, and that the shared equipment is not damaged or does not malfunction.

Specifically, the bottom of the equipment slot of the leasing device is provided with a data-power pin, and correspondingly, the end portion of the shared equipment is also provided with a data-power pin. When the end portion of the shared equipment is inserted into the bottom of the equipment slot and the data-power pin of the shared equipment is in contact with the data-power pin of the leasing device, the main chip charges the shared equipment through the data-power pin, reads the attribute data in the RFID chip built in the shared equipment, and transmits the attribute data to the cloud server for verification. Moreover, in order to improve security, after the attribute data is written into the RFID chip, the storage area in which the attribute data is written in the RFID chip is locked so as to ensure that the data stored in the storage area cannot be subsequently modified.

Moreover, the shared equipment leasing device further includes a sensor, a camera, a code scanner, a speaker and a display screen. When it is detected by the sensor that a person approaches the shared equipment leasing device, the camera is controlled to photograph through the main chip, when no new leasing order is detected while the shared equipment is removed from the equipment slot, a warning is sounded through the speaker and the image information captured by the camera is sent to the cloud server, in order to enable the cloud server to generate an alarm information according to the image information and to send the alarm information to the designated management personnel by mail, massage, telephone, etc. The safety of the shared equipment leasing device is improved and the possible loss is reduced.

Moreover, the shared equipment is provided with a built-in power supply for supplying power to an anti-theft system including the main chip, the sensor, the camera, the code scanner, the speaker and the display screen when an external power is not accessed to, which ensures the normal operation of the components of the anti-theft system, and the built-in power supply is controlled to be charged by the external power supply when it is available. The anti-theft system is powered by the built-in power supply, avoiding that when only the external power supply is available, the anti-theft system cannot operate if the external power supply is destroyed.

Moreover, when an information sent by the cloud server that the user has completed the returning operation is received, a request for clearing the pre-designated user information is sent to the cloud server so that the cloud server clears the pre-designated user information from the database, wherein the user information may include personal information of the user and information generated in the shared equipment for use by the user. The security and confidentiality of the information for users are improved.

For details not provided in this embodiment, reference may be made to the description of other embodiments.

In the embodiment according to the present invention, the electromagnetic lock is controlled to open the buckle by the main chip of the shared equipment leasing device and the shared equipment inserted in the equipment slot is ejected by the spring, and wherein the electronic holder is controlled to lock the shared equipment by the main chip when the shared equipment is inserted into the equipment slot. The leasing device could have its usability improved with more convenience for ejecting or inserting the shared equipment due to the setting of the electromagnetic lock, the buckle and the spring. Moreover, by means of charging the shared equipment by the data-power pin, reading various data from the shared equipment, and sending the read data to the cloud server for processing, the data processing capability in the shared equipment can be improved, the data processing success rate and the data processing amount of the shared equipment in the leasing process are greatly improved, so that the leasing process is successfully completed, and the shared leasing service demand for the shared equipment with a more complex structure is met, and the user experience is improved.

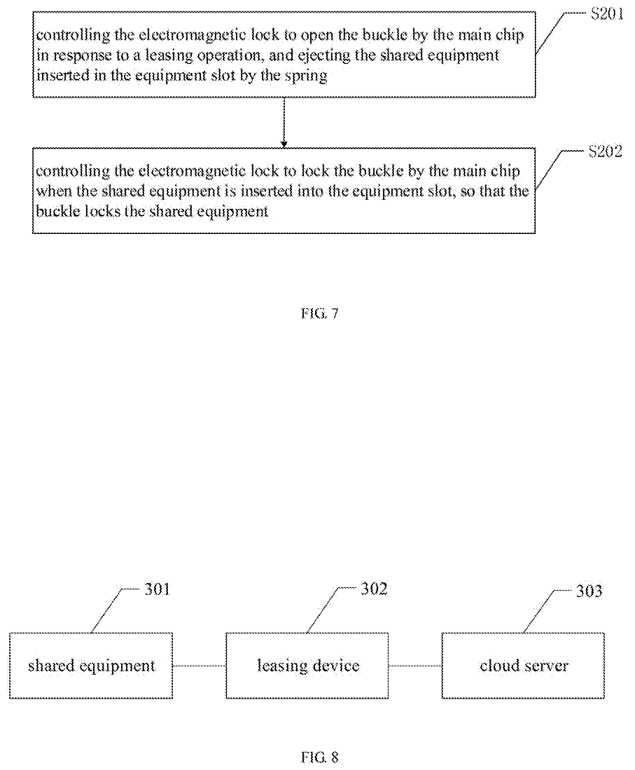

Referring to FIG. 8, it schematically shows a structural view of a shared equipment leasing system according to an embodiment of the present invention. For ease of illustration, only portions related to embodiments of the present invention are shown. The shared equipment leasing system illustrated in FIG. 8 includes the leasing device provided in the foregoing embodiments shown in FIGS. 1 to 6. The system includes a shared equipment 301, a leasing device 302 and a cloud server 303.

As shown in FIG. 1, the leasing device 302 includes a cabinet body 10, a power management module 19, a communication module 16 and an interpreter 34, the cabinet body 10 being provided with a main chip 11 an electromagnetic lock 12, an equipment slot 13, a buckle 14 and a spring 15 therein.

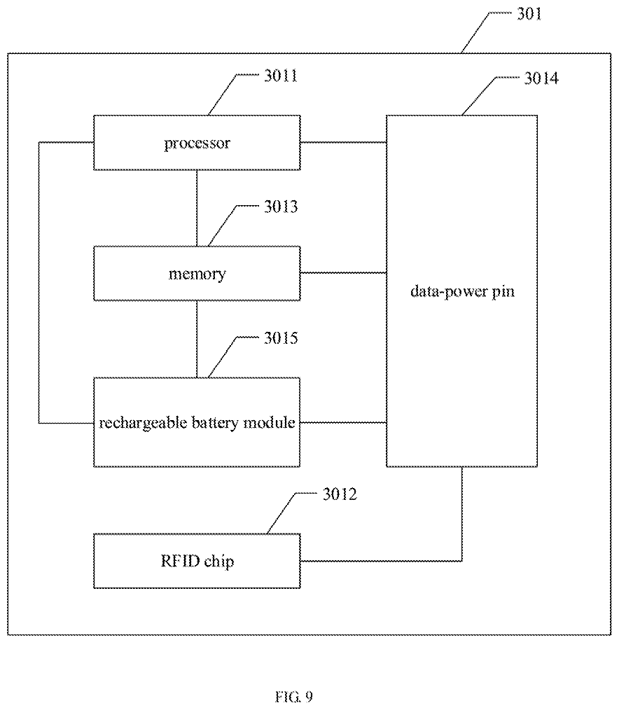

As shown in FIG. 9, the sharing device 301 includes a processor 3011, an RFID chip 3012, and a memory 3013. A computer program executable by the processor 3011 is stored on the memory. The memory is also configured to store user data generated by the computer program. In a practical application, the shared equipment 301 may be, for example, an electronic equipment having a user data recording function, such as a translation machine, a media player, and a tablet computer.

Before being leased, the shared equipment 301 is inserted into the equipment slot 13 of the leasing device 302, and the electromagnetic lock 12 of the leasing device 302 locks the buckle 14 to lock all the shared equipment 301 in the equipment slot 13.

A data connection between the leasing device 302 and the cloud server 303 is established through the communication module 16.

The leasing device 302 is configured to, in response to a leasing operation and by means of the main chip 11, control the electromagnetic lock 12 in the leasing device 302 to open the buckle 14 in the target equipment slot 13 to which the leasing information is directed, and to eject the shared equipment 301 inserted in the equipment slot 13 by the spring 15 in the target equipment slot 13.

The leasing device 302 is further configured to control the electromagnetic lock 12 to lock the buckle 14 so as to lock the inserted shared equipment 301 by the main chip 11 when the shared equipment 301 is inserted into the equipment slot 13, and to control the power management module 19 to charge the inserted shared equipment 301, and to read a unique identification information of the inserted shared equipment 301 stored in the RFID chip by the interpreter 34, and to send the unique identification information to the cloud server 303 through the communication module 16.

The leasing device 302 is further configured to perform malfunction detection on the inserted shared equipment 301 by the main chip 11, and to send the unique identification information and the malfunction information of the inserted shared equipment 301 to the cloud server 303 when a malfunction of the inserted shared equipment 301 is detected.

Moreover, an infrared sensor is provided in the equipment slot 13 of the leasing device 302. After the shared equipment 301 inserted in the equipment slot 13 is ejected by the spring 15, the leasing device 302 is further configured to, by means of the main chip H, determine whether the shared equipment 301 is removed by the user based on the sensed data transmitted from the infrared sensor to the main chip 11. If the shared equipment 301 is removed by the user, the communication module 16 sends the unique identification information and the removal time of the shared equipment 301 to the cloud server 303. The cloud server 303 is further configured to update the leasing data of the removed shared equipment 301 according to the unique identification information and the removal time sent by the leasing device 302. If the ejected shared equipment 301 is not removed by the user as a preset time period is exceeded, the leasing device 302 controls the electromagnetic lock 12 to re-lock the buckle 14 through the main chip 11, and sends to the cloud server 303 a notification that the shared equipment 301 is not removed.

Moreover, as shown in FIG. 1, the bottom of the equipment slot 13 of the leasing device 302 is provided with a data-power pin 18, and correspondingly, the end portion of the shared equipment 301 is also provided with a data-power pin 3014. The shared equipment 301 also includes a rechargeable battery module 3015. The processor 3011, the memory 3013 and the rechargeable battery module 3015 are electrically connected with each other via bus lines.

The data-power pin 18 includes a positive power pin and a negative power pin electrically connected to the power management module 19, a first data transmission pin electrically connected to the interpreter 34, and a second data transmission pin electrically connected to the main chip 11. The data-power pin 3014 includes an RFID contact electrically connected to the MD chip, a positive charging contact and a negative charging contact electrically connected to the rechargeable battery module 3015, and a data transmission pin electrically connected to the processor 3011 and/or the memory 3013. The leasing device 302 reads the relevant data in the shared equipment 301 through the data-power pin 18 and the data-power pin 3014, and sends the relevant data to the cloud server 303 for processing. The cloud server 303 is further configured to process the data sent by the leasing device 302, for example, to determine whether the shared equipment inserted into the equipment slot 13 malfunctions according to the data, to manage the leasing data of the shared equipment, and the like.

Take the translation machine as an example, during leasing, the user triggers a leasing operation by pressing a leasing button on leasing device, and in response to the leasing operation, the main chip of the leasing device controls to turn on the code scanner to scan the QR code shown on the user's mobile phone, so as to obtain account information for the user. Then, the main chip controls the electromagnetic lock corresponding to the equipment slot to which the leasing button is directed to open the buckle on the equipment slot, and the spring at the bottom of the equipment slot ejects the translation machine inserted in the equipment slot. Then, after detecting that the translation machine is removed, the main chip sends to the cloud server the leasing data including the identity information and the removal time of the translation machine, as well as the account information of the user. The cloud server stores the received leasing data, and deducts the deposit from the user's account according to the account information of the user. If the translation machine is not removed by the user as a preset time period is exceeded, the main chip controls the electromagnetic lock to lock the buckle so as to lock the translation machine, and sends to the cloud server a notification that the leasing operation is invalid. The cloud server terminates the leasing operation according to the notification, and sends a message to the user's mobile phone to inform the failed leasing operation.

During returning, the user inserts the translation machine into any one of the empty equipment slots in the leasing device. When the translation machine is fully inserted into the bottom of the empty equipment slot, the second data-power pin at the end portion of the translation machine is in contact with the first data-power pin at the bottom of the empty equipment slot, the first data-power pin sends a high-level hot-plug detection signal to the main chip of the leasing device to inform that an translation machine is inserted. The main chip controls the electromagnetic lock corresponding to the empty equipment slot to lock the buckle on the empty equipment slot, so that the buckle locks the inserted translation machine, and meanwhile controls the power management module to charge the translation machine. The main chip also reads the unique identification information of the translation machine stored in the RFID chip of the translation machine through the interpreter, and commands the translation machine to restart through the first data-power pin.

On the one hand, if receiving the feedback information of successful restart sent by the translation machine, the main chip confirms that the translation machine does not malfunction, and sends the unique identification information of the translation machine to the cloud server. Meanwhile, the main chip commands the translation machine to perform an initialization operation through the first data-power pin to clear the user data stored in the translation machine, such as recorded audio data, translating data and the like, thereby ensuring information security for the user. The cloud server confirms the successful return of the translation machine according to the unique identification information of the translation machine sent by the main chip, returns the deducted deposit to the user's account, and deducts the rent from the user's account.

On the other hand, if the feedback information of successful restart sent by the translation machine is not received beyond the preset time period, the main chip confirms that the translation machine malfunctions, and sends the malfunction information and the unique identification information of the translation machine to the cloud server. According to the malfunction information, the cloud server sends a notification of the malfunction information to a reserved mobile phone to inform that the returned translation machine malfunctions, so as to realize the rapid recovery and maintenance of the translation machine when it malfunctions. The reserved mobile phone includes the mobile phone of the user and the mobile phone of the maintenance personnel. Meanwhile, according to the malfunction information and the unique identification information of the translation machine, the cloud server confirms that the translation machine is returned successfully, returns the deducted deposit to the user's account, and deducts the rent and maintenance fee from the user's account.

In the case of theft-proofing, the main chip of the leasing device controls the camera to be turned on and photograph the scene in front of the lens when an approaching person is sensed by the infrared sensor. If removal of the translation machine from the equipment slot is detected, it is inquired whether there is a record of triggering the leasing operation or whether a new leasing order is generated. If there is no record of triggering the leasing operation or no new leasing order, a warning is sounded through the speaker and a warning information is generated. The captured image or image information and the warning information is sent to the cloud server, so that the cloud server generates an alarm information according to the image information and sends the alarm information to the designated management personnel. In this way, the safety of the translation machine to be leased in the leasing device is ensured, the translation machine is prevented from being stolen, and the stolen equipment can be recovered as soon as possible.

For details not provided in this embodiment, reference may be made to the description of the embodiments shown in FIGS. 1-7.

In the embodiment according to the present invention, the electromagnetic lock is controlled to open the buckle by the main chip of the shared equipment leasing device and the shared equipment inserted in the equipment slot is ejected by the spring, and wherein the electronic holder is controlled to lock the shared equipment by the main chip when the shared equipment is inserted into the equipment slot. The leasing device could have its usability improved with more convenience for ejecting or inserting the shared equipment due to the setting of the electromagnetic lock, the buckle and the spring. The leasing device communicates with the RFID chip in a manner of contact communication, which not only remains the advantage of small size occupied by the RFID chip, but also avoids the defects that the radio frequency communication cannot control the distance and the transmission range and reduces cost for the hardware.

Described above are merely preferred embodiments of the shared equipment leasing device, method and system therefor provided by the present invention. For those skilled in the art, changes might be made in specific embodiments and application scope according to the idea of the embodiments of the present invention. The description is not to be construed as limiting the invention.

What is claimed is:

1. A shared equipment leasing device, comprising:
a cabinet body and a power management module, the cabinet body being provided with a main chip, a electromagnetic lock, an equipment slot, a buckle and a spring arranged therein; wherein,
the main chip is electrically connected to the power management module and the electromagnetic lock;
the buckle and the spring are arranged in the equipment slot, and the electromagnetic lock is connected to the buckle;
the main chip is configured to control the electromagnetic lock to open or lock the buckle; and
the spring is configured to eject the shared equipment inserted in the equipment slot after the main chip controls the electromagnetic lock to open the buckle.

2. The device according to claim 1, further comprising a control board electrically connected to the main chip and the electromagnetic lock, wherein the electromagnetic lock comprises a connecting shaft and a driver, the equipment slot having one side perpendicular to the bottom of the equipment slot and provided with a protrusion, the buckle having one end fixed to the connecting shaft and another end fixed to the protrusion;
wherein the control board is electrically connected to the driver, and is configured to, in response to a control command transmitted from the main chip, control the driver to drive the connecting shaft to move in a direction parallel to the bottom of the equipment slot 13, and then feedback a control result to the main chip.

3. The device according to claim 1, wherein the bottom of the equipment slot is provided with a data-power pin comprising a positive power pin and a negative power pin electrically connected to the power management module, and the end portion of the shared equipment is provided with a positive charging contact and a negative charging contact;
wherein the main chip is further configured to charge the shared equipment when the positive charging contact and the negative charging contact of the shared equipment are respectively in contact with the positive power pin and negative power pin.

4. The device according to claim 1, further comprising
an interpreter and a communication module electrically connected to the main chip, wherein the data-power pin further comprises a first data transmission pin electrically connected to the interpreter, and the shared equipment further comprises a RFID chip arranged therein and a RFID contact arranged at the end portion of the shared equipment and electrically connected to the RFID chip;
wherein the main chip is further configured, when the RFID contact is in contact with the first data transmission pin, to read a unique identification information stored in the RFID chip via the interpreter;
wherein the main chip is further configured to send the read unique identification information to the cloud server via the communication module;
wherein the data-power pin further comprises a second data transmission pin, the end portion of the shared equipment is provided with a data transmission pin electrically connected to a processor and/or a memory of the shared equipment;
the main chip is further configured to send a first command for clearing a first target data in the shared equipment to the shared equipment when the data transmission pin of the shared equipment is in contact with the second data transmission pin;
the main chip is further configured, when the data transmission pin of the shared device is in contact with the second data transmission pin, to read a second target data in the shared equipment, and to send the second target data to the cloud server via the communication module;
the main chip is further configured to send a second command for controlling restarting of the shared equipment to the shared equipment when the data transmission pin of the shared equipment is in contact with the second data transmission pin;
the main chip is further configured to send a malfunction information to the cloud server via the communication module when the shared equipment fails to start.

5. The device according to claim 3, further comprising a plurality of external appliances detachably disposed on the outer surface of the cabinet body;
wherein the plurality of external appliances comprises a sensor, a camera, a code scanner, and a display screen;
the sensor is configured to detect whether a user approaches;
the camera is configured to acquire the user's characteristics;
the code scanner is configured to scan a bar code;
the display screen is configured to display a text prompt information and/or an interface for collection of user's characteristics.

6. A shared equipment leasing method for leasing a shared equipment through a shared equipment leasing device, wherein the shared equipment leasing device comprises a cabinet body having a main chip, a power management module, an electromagnetic lock and an equipment slot provided therein, wherein the equipment slot comprises a buckle and a spring arranged therein, the main chip is electrically connected to the power management module and the electromagnetic lock, and the electromagnetic lock is connected to the buckle, and wherein the method comprises:
controlling the electromagnetic lock to open the buckle by the main chip in response to a leasing operation, and ejecting the shared equipment inserted in the equipment slot by the spring;
controlling the electromagnetic lock to lock the buckle by the main chip when the shared equipment is inserted into the equipment slot, so that the buckle locks the shared equipment.

7. The method according to claim 6, wherein the shared equipment leasing device further comprises an interpreter, and wherein the method further comprises:
acquiring, when the shared equipment is inserted into the equipment slot, a unique identification information of the shared equipment through the interpreter, controlling the power management module to charge the shared device through the main chip and detecting whether the shared equipment malfunctions;
sending, if the shared device malfunctions, a malfunction information and the unique identification information to the cloud server through the main chip, and controlling a malfunction indicator lamp of the shared equipment leasing device to be illuminated and/or displaying the malfunction information on the display screen of the shared equipment leasing device;
sending, if the shared equipment does not malfunction, a data-clearing command to the shared equipment through the main chip, the data-clearing command being used to clear a first target data in the shared equipment;
or reading, if the shared device does not malfunction a second target data in the shared equipment through the main chip and sending the unique identification information and the read second target data to the cloud server;
wherein the detecting whether the shared equipment malfunctions comprises
commanding the shared equipment to restart through the main chip, determining that the shared equipment malfunctions if the shared equipment fails to start, or determining that the shared equipment does not malfunction if the shared equipment starts successfully;
or,
reading elements data of the shared equipment if the share device starts successfully and comparing the read elements data with a preset data, determining that the shared equipment malfunctions if the elements data is not inconsistent with the preset data, or determining that the shared equipment does not malfunction if the elements data is consistent with the preset data.

8. The method according to claim 7, wherein the shared equipment leasing device further comprises a sensor, a camera, a code scanner, a speaker and a display screen, and wherein the method further comprises:
controlling the camera to photograph through the main chip when it is detected by the sensor that a person approaches;
sounding a warning through the speaker and sending an image information captured by the camera to the cloud server when no new leasing order is detected while the shared equipment is removed from the equipment slot, in order to enable the cloud server to generate an alarm information according to the image information and to send the alarm information to the designated management personnel.

9. The method according to claim 8, further comprising
sending a request for clearing a pre-designated user information to the cloud server when an information sent by the cloud server that the user has completed the returning operation is received, so that the cloud server clears the user information.

10. A shared equipment leasing system, comprising:
a shared equipment provided with a built-in RFID chip, a leasing device and a cloud server;
wherein the leasing device comprises a cabinet body, a power management module, a communication module and an interpreter, the cabinet body being provided with a main chip, an electromagnetic lock, an equipment slot, a buckle and a spring arranged therein;
a data connection between the leasing device and the cloud server is established through the communication module;
the leasing device is configured to, in response to a leasing operation and by means of the main chip, control the electromagnetic lock in the leasing device to open the buckle in the target equipment slot to which the leasing information is directed, and to eject the shared equipment inserted in the equipment slot by the spring in the target equipment slot;
the leasing device is further configured to control the electromagnetic lock to lock the buckle so as to lock the inserted shared equipment by the main chip when the shared equipment is inserted into the equipment slot, and to control the power management module to charge the inserted shared equipment, and to read a unique identification information of the inserted shared equipment stored in the RFID chip by the interpreter, and to send the unique identification information to the cloud server through the communication module;
the leasing device is further configured to perform a malfunction detection on the inserted shared equipment by the main chip, and to send the unique identification information and a malfunction information of the inserted shared equipment to the cloud server when a malfunction of the inserted shared equipment is detected.
